(19) United States
(12) Patent Application Publication
(10) Pub. No.: US 2024/0278483 A1
(43) Pub. Date: Aug. 22, 2024

(54) NARROWED CONDUITS

(71) Applicant: DROPWORKS, INC., Boulder, CO (US)

(72) Inventors: Kristopher HOLUB, Boulder, CO (US); Matthew Ryan DUNN, Louisville, CO (US); Andrew Carl LARSON, Superior, CO (US); Donna KELLEY, Louisville, CO (US)

(21) Appl. No.: 18/289,792

(22) PCT Filed: May 4, 2022
(86) PCT No.: PCT/US2022/027589

§ 371 Date: Nov. 7, 2023

Related U.S. Application Data
(60) Provisional application No. 63/185,853, filed on May 7, 2021.

(51) Int. Cl. B29C 61/02; B29C 35/02; B29C 35/04; B29D 23/00; B29K 27/12; B29L 23/00

(52) U.S. Cl. CPC B29C 61/025; B29C 35/02; B29D 23/00; B29C 2035/0211; B29C 35/045; B29C 2793/0027; B29K 2027/12; B29L 2023/007

(57) ABSTRACT

Provided herein are methods and compositions for narrowing the inside diameter of tubing, in some cases where the narrowing is provided by a taper on one or both ends of the narrowed portion of the tubing.

### CROSS-REFERENCE

This application claims the benefit of U.S. Provisional Application No. 63/185,853, filed May 7, 2021, which application is incorporated herein by reference.

### BACKGROUND

There are many technologies where it is useful to narrow the diameter of a conduit used in the technology, and in some cases to process the narrowed conduit, e.g., by cutting. For example, droplet-based technologies and others can be conducted in conduits where a narrowing of the conduit can be a useful feature, or aspiration of a sample with a narrowed opening of the aspiration tube, and wherein a tapered transition to the narrowed portion is desirable. Improved methods and compositions for producing such a narrowing are desirable.

### SUMMARY

In one aspect, provided herein are methods.

In certain embodiments, provided is a method for narrowing the inside diameter (ID) of tubing comprising heat-deformable material comprising (i) positioning the tubing inside a conduit, wherein the conduit has an ID greater than the outside diameter (OD) of the tubing: (ii) positioning a mandrel inside the tubing, wherein (a) the mandrel is present at least at an area of the tubing desired to be narrowed, (b) the mandrel has an OD that is substantially equal to a desired ID of a narrowest portion of the narrowed area; and (iii) applying heat to an area of the tubing desired to be narrowed to heat the tubing to a sufficient temperature and for a sufficient time that the ID of the tubing is reduced to the desired diameter in the area. In certain embodiments the conduit has an ID no more than 5% greater than the OD of the tubing. In certain embodiments the ID of the conduit is no more than 2 thousandths of an inch greater than the OD of the tubing. In certain embodiments the method further comprises applying a compressive force to the tubing in the direction of the long axis of the tubing. In certain embodiments the compressive force is in the range of 1000 to 10,000 psi. In certain embodiments the compressive force is applied before heating and maintained during heating. In certain embodiments the compressive force is maintained after heating. In certain embodiments the long axis of the mandrel is within 50 um of the long axis of the tubing in the area in which the tubing is to be narrowed. In certain embodiments the method further comprises, after step (iii), treating the outer surface of the tube to improve its optical characteristics. In certain embodiments the heat-deformable material comprises a thermoplastic material. In certain embodiments the thermoplastic material comprises a fluoropolymer. In certain embodiments the fluoropolymer comprises PFA, FEP, PVDF, ETFE, PCTFE, or ECTFE. In certain embodiments the tubing comprises a material with a glass transition temperature and a melting temperature, wherein the melting temperature is higher than the glass transition temperature. In certain embodiments the tubing is heated to a maximum temperature that is below the melting temperature. In certain embodiments the tubing is heated to a temperature that is within 5% of the glass transition temperature. In certain embodiments the tubing is heated to between 260 and 300° C. In certain embodiments the tubing is heated to a maximum temperature that is below the glass transition temperature. In certain embodiments the tubing is heated by a heating element in contact with the conduit, and the temperature is measured at the heating element or conduit, and the temperature of the tubing is assumed to reach a maximum within 10° C. of the temperature of the heating element or conduit. In certain embodiments the method further comprises stopping the application of heat and allowing the tubing to cool. In certain embodiments the tubing cools while still under compression. In certain embodiments cooling is assisted by flowing a fluid along the exterior of the conduit. In certain embodiments the fluid is air. In certain embodiments the method further comprises removing the tubing from the conduit and removing the mandrel from the tubing. In certain embodiments the method further comprises, after the tubing has been narrowed, cutting the tubing in the narrowed portion. In certain embodiments the conduit comprises metal or glass. In certain embodiments the conduit comprises glass. In certain embodiments the tubing is heated by applying heat to the conduit and allowing heat to be conducted by the conduit to the tubing. In certain embodiments heat is applied to the conduit in a manner that produces a temperature gradient at the tubing along the long axis of the tubing. In certain embodiments the gradient is produced by contacting a heating element to the conduit at a location and allowing the conduction of heat from the location along the axial direction of the conduit to produce a desired temperature gradient. In certain embodiments the length of the temperature gradient is 0.1-10× the OD of the tubing. In certain embodiments the temperature gradient is 1-2 mm. In certain embodiments the area of the tubing to which heat is applied has a length no greater than 2× the OD of the tubing. In certain embodiments heat is applied until a desired temperature is reached. In certain embodiments heat is applied by a heating element and temperature is measured at the heating element. In certain embodiments the tubing is positioned within the conduit so that at least one end of the tubing is within the conduit. In certain embodiments both ends of the tubing are within the conduit.

In another aspect, provided herein are compositions.

In certain embodiments provided is an apparatus for narrowing the ID of tubing comprising heat-deformable material comprising (i) a conduit into which the tubing can be inserted, wherein the conduit (a) has an ID that is greater than the OD of the tubing (b) comprises a material that is capable of conducting heat quickly and uniformly to the tubing and that does not expand sufficiently upon heating to a desired temperature to deform the tubing; (ii) a compression system configured to reversibly apply pressure to one end of the tubing after its insertion into the conduit; (iii) a heating element in contact with the conduit at a location corresponding to the location of the inserted tubing where narrowing of ID is desired; (iv) a mandrel to be inserted into the tubing, wherein the mandrel has an OD corresponding to the desired ID of a desired narrowest portion of the tubing after it is narrowed. In certain embodiments the conduit is oriented within 20 degrees of vertical. In certain embodiments the apparatus further comprises a system to anchor a second end of the tubing after its insertion into the conduit. In certain embodiments the location at which the heating element contacts the conduit has a length that is no more than 2× the OD of the tubing to be narrowed. In certain embodiments the apparatus further comprises a cooling system to cool the conduit after heating. In certain embodiments the cooling system comprises a mechanism to move air across the exterior of the conduit. In certain embodiments the apparatus further comprises a temperature sensor in contact with the heating element, the conduit, the tubing, or a combination thereof. In certain embodiments the apparatus further comprises a control system in communication with the heating element, wherein the control system is configured to modulate heating at the heating element at a predetermined endpoint. In certain embodiments the apparatus further comprises a temperature sensor in contact with the heating element, the conduit, the tubing, or a combination thereof, and in communication with the control system. In certain embodiments the control system sends an output to the heating element to modulate heating at the heating element at least in part in response to information received from the temperature sensor.

In certain embodiments provided is a composition comprising a length of tubing wherein a portion of the tubing comprises a section with a smaller ID compared to other sections, wherein the ID tapers to the narrowed ID over a length of at least 4 times the length of tubing with the narrowed ID, and wherein the tubing has uniform optical transmittance around the circumference of the tubing.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows various configurations of heating elements and resulting narrowing of conduits.

FIG. 2 shows an exemplary cut in a narrowed conduit to produce two conduits with narrowed openings.

FIG. 3 shows a tapered narrowed conduit for use in a droplet system.

FIG. 4 shows a conduit that tapers to a narrowed opening for use as an aspirator, with dimensions to prevent entrance of debris above a certain size.

### DETAILED DESCRIPTION

Provided herein are methods and compositions for narrowing the inside diameter (ID) of tubing that comprises a heat-deformable material. In certain cases a step-down narrowing is desired, but generally, a tapered narrowing is preferable. Certain methods and compositions provided herein allow for a tapered narrowing rather than a step narrowing: in uses in which a fluid is flowed through the conduit this can be advantageous for, e.g., avoiding or minimizing turbulence in the flowing fluid. In some cases, the process results in the narrowed portion with adequate optical properties, e.g., for passage of light to and from the inside of the tubing during sample or other detection. In other cases, optical properties are not a concern. In some cases a narrowed tip, e.g., for aspiration is desired and the tubing may be cut, e.g., perpendicular to the long axis of the tubing, to provide a tip for a conduit that is narrower than the rest of the conduit.

In certain embodiments, the tubing is spot heated while under compression and constrained within a rigid tube, while a mandrel, e.g., wire mandrel is inserted within the tubing itself to constrain the minimum interior diameter.

In addition, the axial temperature gradient has a strong influence on the geometry of the internal diameter taper. A gradual temperature gradient produces a gradual taper, while a rapid temperature gradient can produce nearly shelf-like features. The temperature gradient can be altered by any suitable method: the method used in certain processes disclosed herein is a combination of mold wall thickness and thermal conductivity.

In certain methods disclosed herein, a length of tubing comprising a heat-deformable material is positioned inside a conduit, where the conduit has an ID slightly greater than the outside diameter (OD) of the tubing: a mandrel, e.g., a solid mandrel with the cross-sectional shape and dimensions desired in the final narrowed portion, is positioned inside the tubing at least at an area of the tubing desired to be narrowed, where the mandrel has dimensions of its OD (e.g., diameter, in the case of a cylindrical mandrel) equal to the desired dimensions of the ID of the narrowed portion of the tubing; applying heat to an area of the tubing desired to be narrowed to heat the tubing to a sufficient temperature and for a sufficient time that the ID of the tubing is reduced to the desired dimensions in the area; typically, the tubing is also subjected to a compressive force along the axis of the tubing; the compressive force can be applied before heating and maintained during and after heating, e.g., while the tubing cools.

Tubing to be narrowed may be any suitable material so long as it is heat-deformable and maintains characteristics necessary or desirable for its intended use after the process is completed. In certain embodiments, the tubing material comprises a polymer, such as a fluoropolymer, e.g., PFA, FEP, PVDV, ETFE, PCTFE, ECTFE; in certain embodiments the tubing comprises PFA or FEP. The created geometry is primarily controlled by the applied temperature profile, mold geometry, and forces applied to the heated material.

The starting dimensions of the tubing, i.e. ID and OD, can be any suitable dimensions, so long as the thickness of the wall of the tubing is not so great that heat applied to the outside is not uniformly distributed through the wall and leads to deformation. An exemplary tubing is PFA tubing with a 1/16″ OD and 0.01, 0.02, or 0.03″ ID; however, these are merely exemplary and any suitable material of suitable OD and ID may be used.

Any suitable material may be used for the mandrel so long as it is resistant to kinking, is strong enough that when extracted from the tubing it does not break and/or become stuck, has the desired dimensions for the ID of the narrowed portion of the conduit, and can withstand the process temperatures. Exemplary materials include stainless steel, tungsten, and nitinol. In certain embodiments, the mandrel comprises nitinol, e.g., a nitinol wire. When the mandrel is inserted into the tubing before heating, there will be space between the outer surface of the mandrel and the inner surface of the tubing. In certain embodiments, it can be desirable to keep the space relatively even around the mandrel, e.g., in order to ensure an even axis for the tubing in the narrowed portion, i.e., the axis does not become skewed in the narrowed portion. Thus, in certain embodiments, the mandrel is inserted into the tubing so that it is centered or substantially centered in the tubing, i.e., its axis is within a certain distance of the axis of the tubing in the area in which the tubing is to be narrowed, for example, the axis of the mandrel is not more than 0.1, 0.2, 0.5, 0.7, 1, 1.2, 1.5, 1.7, 2, 2.5, 3, 4, 5, 7, 10, 15, 20, 30, 40, 50, 60, 70, 80, 90, 100, 120, 150, or 200 um from the axis of the tubing in the portion of the tubing to be narrowed, for example, within 50 um. In order to insert the mandrel to achieve the desired conformity to the axis of the tubing, it can be useful to insert the mandrel with the tubing and the mandrel in a vertical orientation, allowing the mandrel to “float” to the proper position within the tubing. The mandrel may be inserted into the tubing in any desired manner: in certain embodiments, the mandrel is inserted first into the conduit, e.g., from the top down, then the tubing is inserted into the conduit with the mandrel simultaneously inserted into the tubing, e.g., from the bottom up.

The conduit can comprise any suitable material so long as it conducts heat in a manner needed in the process, does not substantially expand or contract on heating and cooling, and has an inner surface that does not interact with the tubing in such a manner as to make removal of the tubing after heating and cooling excessively difficult. In addition, the tubing generally will conform to the inner surface of the conduit and in tubing which will be used for optical purposes it is desirable to have a sufficiently smooth outer surface to allow the optical process for which it is used, though in certain embodiments the outer surface of the tubing may be treated to smooth it and provide improved optical properties. Glass can be used and has the advantage that the inner surface is very smooth, imparting a smooth surface finish to the tubing. Other exemplary materials include metals, high temperature plastics, and ceramics. Certain polymers, such as PFA, when heated to high enough temperatures, can be corrosive to some materials, e.g., steel, and these should be avoided.

The ID of the conduit is slightly greater than the OD of the tubing. In certain embodiments, the conduit has an ID at least 0.1, 0.2, 0.3, 0.4, 0.5, 0.6, 0.7, 0.8, 0.9, 1, 1.1, 1.2, 1.5, 1.7, 2, 3, 4, 5, 7, 10, 15, 20, 30, or 40% greater than the OD of the tubing and/or not more than 0.2, 0.3, 0.4, 0.5, 0.6, 0.7, 0.8, 0.9, 1, 1.1, 1.2, 1.5, 1.7, 2, 3, 4, 5, 7, 10, 15, 20, 30, 40, or 50% greater than the OD of the tubing, e.g., not more than 1, 5, 10, 20, 30, 40, or 50% greater than the OD of the tubing. In certain embodiments, the ID of the conduit is at least 0.1, 0.2, 0.5, 0.7, 1, 1.2, 1.5, 1.7, 2, 2.2, 2.5, 2.7, 3, 3.5, 4, 4.5, 5, 6, 7, 8, 10, 12, 15, or 20 thousandths of an inch greater than the OD of the tubing and/or not more than 0.2, 0.5, 0.7, 1, 1.2, 1.5, 1.7, 2, 2.2, 2.5, 2.7, 3, 3.5, 4, 4.5, 5, 6, 7, 8, 10, 12, 15, 20 or 25 thousandths of an inch greater than the OD of the tubing, for example, 0.1-10 thousandths of an inch greater, such as 0.2-8 thousandths of an inch greater, e.g., 1-5 thousandths of an inch greater.

Generally, the conduit is fixed into position during the process. Any suitable orientation may be used, such as a vertical orientation.

Once the mandrel is inserted into the tubing and the tubing inserted into the conduit, the ends of the tubing can be fixed, using any suitable method so long as the tubing is fixed, i.e., immobile or substantially immobile, and a compressive force can be applied to the tubing, e.g., via the fixing material. Exemplary methods of fixing the tubing include use of a piece that butts up against the top of the tubing and another piece that butts up against the bottom end of the tubing, or by inserting a tapered needle that is tapered to an end with a smaller OD than the tubing and expands to have an OD greater than that of the tubing, into the top and/or bottom of the tubing until the needle is firmly inserted and substantially immobile, or a combination of the two.

An axial compressive force is applied to the tubing, that is, a compressive force in the direction of the axis of the tubing. In certain embodiments, the force is applied before the tubing is heated and is maintained during heating and cooling of the tubing. Any suitable method may be used to apply a compressive force to the tubing, such as a spring or weight. A weight has the advantage of supplying consistent compression across runs. It will be appreciated that if the ID of the tubing is to be decreased without also decreasing the OD of the tubing, additional material must be supplied to the area where the narrowing is occurring: the compressive force pushes material toward the narrowing to supply the needed additional material and, typically, the length of the tubing will be somewhat shorter after the narrowing process than before.

Any suitable compressive force may be applied, such as at least 10, 100, 200, 300, 400, 500, 600, 700, 800, 900, 1000, 1200, 1500, 2000, 2500, 3000, 3500, 4000, 4500, 5000, 6000, 7000, 8000, 9000, 10,000, 12,000, or 15,000 psi and/or not more than 100, 200, 300, 400, 500, 600, 700, 800, 900, 1000, 1200, 1500, 2000, 2500, 3000, 3500, 4000, 4500, 5000, 6000, 7000, 8000, 9000, 10,000, 12,000, 15,000, or 20,000 psi, for example 100-5000, or 200-4000, or 500-3000, or 500-2000, or 500-1500 psi. In some cases, the degree of taper may be related to compressive force and to heating, and a suitable combination of the two is desirable.

When the tubing, conduit, and mandrel are fixed in position and the desired compressive force is applied, heat is applied so that it is transmitted to the tubing: any suitable means of applying heat may be used, such as applying heat to the conduit, which transmits it to the tubing. Thus a system for the processes provided herein will comprise a heating element that can be heated to a desired temperature and applied to the materials, e.g., the conduit, over an area and with sufficient uniformity to produce the desired result.

The maximum temperature reached, which, in embodiments where the conduit is heated and transmits heat to the tubing can be considered to be the temperature applied to the conduit, e.g., the temperature of a heating element in contact with the conduit, or the conduit itself, can be any suitable temperature that allows the tubing to narrow with sufficient precision and properties for its intended function. Many materials exist in a crystalline state at low temperatures, e.g., room temperature, then, on heating, experience a transition to a state that is no longer crystalline and not liquid, i.e., an amorphous deformable solid state, at a glass transition temperature, then transition to a melted, i.e., liquid, state at a higher melting temperature. The process works best when the temperature applied is kept near the glass transition temperature of the tubing material, which allows the material to deform and assume the intended shape, but below the melting temperature of the tubing material, at which the material will tend to stick to the conduit. Thus, in certain embodiments, heat is applied to achieve a temperature below the melting temperature of the tubing, e.g., in a range from at or near the glass transition temperature of the tubing material to below its melting temperature. In certain embodiments, the temperature of the heating element, or conduit to which the heating element is applied, is within 1, 2, 5, 7, 10, 12, 15, 20, 25, 30, 40, or 50% of the glass transition temperature of the tubing material, for example, within 5%. In certain embodiments, the temperature of the heating element, or conduit to which the heating element is applied, is below the glass transition temperature of the tubing material. In embodiments where PFA is the tubing material, the temperature of the heating element, or conduit to which the heating element is applied, is 200-350, 220-340, 240-320, 250-310, or 260-300° C., for example 260-300° C. The heating element may be held at the peak temperature for any suitable amount of time, e.g., at least 0.1, 0.2, 0.3, 0.4, 0.5, 0.6, 0.7, 0.8, 0.9, 1, 1.2, 1.5, 1.7, 2, 2.2, 2.5, 2.7, 3, 3.5, 4, 4.5, 5, 5.5, 6, 7, or 8 minutes, and/or not more than 0.2, 0.3, 0.4, 0.5, 0.6, 0.7, 0.8, 0.9, 1, 1.2, 1.5, 1.7, 2, 2.2, 2.5, 2.7, 3, 3.5, 4, 4.5, 5, 5.5, 6, 7, 8 or 10 minutes. In certain embodiments, the peak temperature is reached then the heating element is immediately cooled. In certain embodiments, the heating element is activated until a predetermined temperature is reached, then activation is ceased: the heating element may continue to heat but it will achieve a peak temperature then immediately start to cool, so that the element is not held for any substantial amount of time at the peak temperature. In certain embodiments, a heating element is activated and rapidly increases temperature to the desired temperature, e.g., within 10, 8, 6, 5, 4, 3, 2, or 1 minute, for example, 1-4 minutes, or 1-3 minutes, in some cases 1-2 minutes. Once the desired temperature is reached by the heating element, activation is stopped. There can be some overshoot after activation is stopped, e.g., by 5-10° C., but the maximum temperature can be considered to be the temperature the heating element reached before activation was stopped.

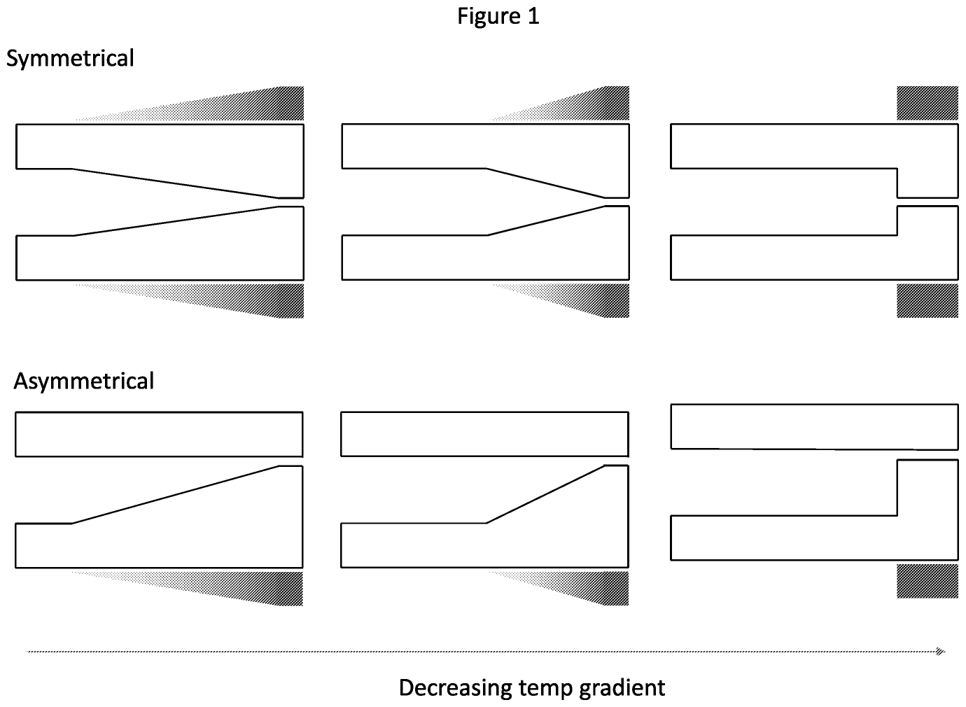

In certain embodiments, a temperature gradient is formed, which will form a tapered ID in the tubing as it narrows to its narrowest dimension. Temperature gradients are important for the formation of the internal geometry of the tubing. Gradients can be thought of being both parallel (axial) to the tubing, and across (lateral) to the tubing. Gradual axial gradients promote the formation of a tapered interior geometry, while an abrupt gradient forms a step-like structure. Asymmetric lateral gradients cause the geometry to bias towards the colder side. See FIG. 1, which shows various gradients and the resulting narrowing of a conduit. In certain embodiments, heat is applied to implement a radially-symmetric, axially-gradual temperature gradient. Any suitable gradient may be used so long as the desired taper of the narrowing is achieved. In certain embodiments, the length of the gradient (from lowest temp to highest) is at least 0.1, 0.2, 0.5, 0.7, 1.0, 1.3, 1.5, 1.7, 2, 2.5, 3, 3.5, 4, 5, 6, 7, 8, 9, or 10× the OD of the tubing and/or not more than 0.2, 0.5, 0.7, 1.0, 1.3, 1.5, 1.7, 2, 2.5, 3, 3.5, 4, 5, 6, 7, 8, 9, 10 or 15× the OD of the tubing, e.g., 1-3× the OD of the tubing. In certain embodiments, the length of the temperature gradient is 0.1, 0.2, 0.5, 0.7, 1, 1.2, 1.4, 1.6, 1.8, 2, 2.2, 2.4, 2.6, 2.8, 3, 3.2, 3.5, 3.7, 4, 4.5, 5, 6, 7, 8, 9, 10, 12, 15, or 20 mm and/or not more than 0.2, 0.5, 0.7, 1, 1.2, 1.4, 1.6, 1.8, 2, 2.2, 2.4, 2.6, 2.8, 3, 3.2, 3.5, 3.7, 4, 4.5, 5, 6, 7, 8, 9, 10, 12, 15, 20, or 30 mm. The gradient may be linear or substantially linear, or any other suitable curve shape. There can be a gradient on one side of the narrowed portion, or on both sides: if on both sides, the gradient may be the same or different on each side. The taper in the narrowing of the will generally follow the gradient: in certain embodiments where the narrowed tubing is to be used to contain a flowing fluid, a gradient is provided that allows sufficiently gradual change that no or substantially no turbulent flow is introduced at the flow rates at which the fluid is flowing. In addition, the narrowest portion of the tubing, where the taper ends and where the diameter is relatively constant, may be any suitable length: in flowing embodiments the taper and the narrowest portion may be such that an unacceptable pressure drop is not created. In certain embodiments, the narrowest portion of the conduit, typically with taper on one or both sides, is at least 10, 50, 70, 100, 120, 140, 160, 180, 200, 220, 240, 260, 280, 300, 320, 350, 400, 450, 500, 600, 700, 800, 900, 1000, 1200, 1500, 1700, 2000, 2500, 3000, 3500, 4000, 4500, or 5000 um in length and/or not more than 50, 70, 100, 120, 140, 160, 180, 200, 220, 240, 260, 280, 300, 320, 350, 400, 450, 500, 600, 700, 800, 900, 1000, 1200, 1500, 1700, 2000, 2500, 3000, 3500, 4000, 4500, 5000, or 10,000 um in length, for example 50-5000 um, or 100-3000 um, or 200-2000 um. Generally, the narrowest portion is formed by heating the conduit and thus the tubing in a uniform manner along the length desired for the narrowest portion. Thus, in certain embodiments, heat is applied as an increasing gradient of a first length, uniformly for a second length, and, optionally, as a decreasing gradient for a third length, each of which can be any suitable length, as described herein: typically the first and third lengths correspond to the lengths of taper on the interior of the tubing leading to and away from the narrowest portion, and the second length to the length of the narrowest portion of the tubing.

The temperature gradient may be achieved in any suitable manner. In some cases, a heat source, such as a heat gun, is placed in contact with the conduit in an area to be the center of the narrowed portion of the tubing. The contact is sufficient around the conduit to provide a uniform heating, if desired, or the contact may be adjusted to provide non-uniform heating around the conduit if a non-uniform reduction of ID of the tubing is desired, i.e., radially asymmetric heating. The length of the conduit contacted may be any suitable length, such as at least 0.1, 0.2, 0.5, 0.6, 0.7, 0.8, 0.9, 1, 1.1, 1.2, 1.3, 1.4, 1.5, 1.6, 1.7, 1.8, 1.9, 2, 2.2, 2.5, 2.7, 3, 3.5, 4, 4.5, 5, 5.5, 6, 7, 8, 9, 10, 12, 15, or 20 mm and/or not more than 0.2, 0.5, 0.6, 0.7, 0.8, 0.9, 1, 1.1, 1.2, 1.3, 1.4, 1.5, 1.6, 1.7, 1.8, 1.9, 2, 2.2, 2.5, 2.7, 3, 3.5, 4, 4.5, 5, 5.5, 6, 7, 8, 9, 10, 12, 15, 20, or 30 mm, such as 0.5-5 mm, for example 0.5-3 mm, in some cases 1-2 mm. This length will typically correspond to the length of the narrowest portion of the tubing, with a taper forming to and from the narrowest portion on either side of the contact length. The temperature gradient is created by heat transfer longitudinally along the conduit from the heat source, so that the highest temperature is achieved where the heat source directly contacts the conduit, and temperature decreases as a gradient from either side of the direct contact of the heat source. A thinner, less conductive conduit will result in larger temperature gradient, while a thicker, more conductive mold will cause a more gradual gradient. It is also possible to use multiple temperature-controlled zones, e.g., to use a multistage heating element.

After heating, the materials are cooled. Cooling may be passive, i.e., simply allowing heat to transfer from material to room air without manipulation, or active, i.e., accelerating heat transfer from the materials, for example, by contacting the materials with a flowing fluid. In certain embodiments, cooling is achieved by moving air across the heated materials, e.g., by a fan. More generally, a system may comprise a cooling element, such as a fan. In certain embodiments, the tubing is under compression while heat is applied and while cooling to a certain maximum cooled temperature, which is typically well below a glass transition temperature for the tubing material but above room temperature, for example, with PFA tubing compression may be kept on the tubing until it reaches 180° C. It is also generally desirable to heat the material and cool the material quickly: in the case of cooling, rapid cooling can improve dimensional stability but may also reduce crystallinity, but generally sufficient crystallinity can be maintained to allow the desired optical properties even with rapid cooling. Thus, cooling from the maximum temperature achieved to a desired temperature, e.g., a temperature well below the glass transition temperature of the tubing material, for example, at least 200, 150, 120, 110, 100, 90, 80, 70, 60, or 50° C. below the glass transition temperature, can be done in less than 10, 8, 6, 5, 4, 3, 2, or 1 minute, for example, 1-4 minutes, or 1-3 minutes, in some cases 1-2 minutes.

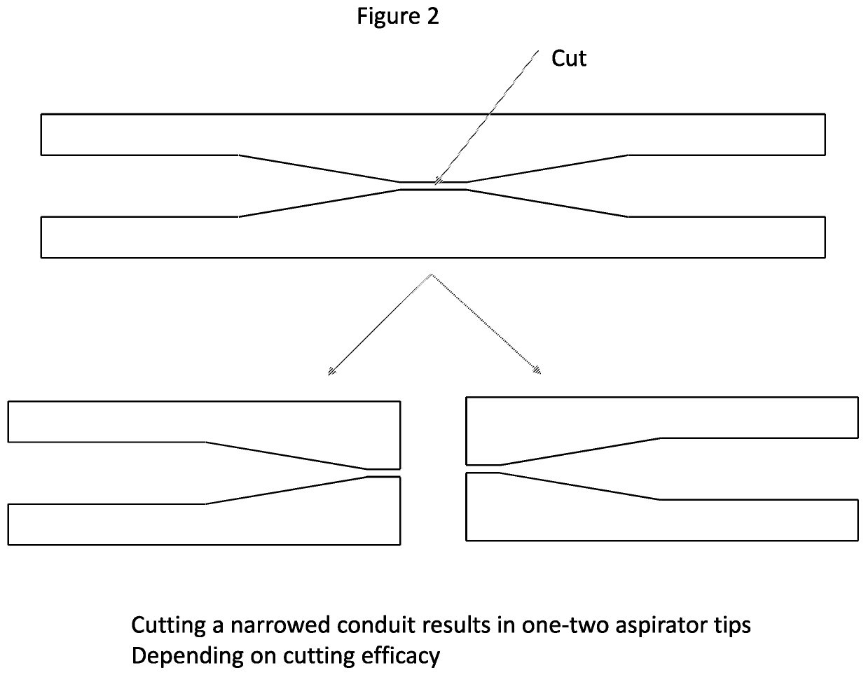

After the tubing and conduit have cooled to a sufficiently low temperature, the tubing is removed from the conduit and the mandrel is removed from the tubing. In some cases where the narrowed section is to be used in applications where light will pass through the tubing, the exterior surface of the narrowed section can be further treated to improve the optical properties, e.g., with a grit abrasive to polish the exterior: the abrasive can be in any suitable form, such as sandpaper, e.g., fine grit sandpaper such as 6000 or 12,000 grit sandpaper, and/or as a liquid abrasive for a final polish. In general, the interior of the tubing does not require treatment for improving optical properties. In certain embodiments a cut is made in the narrowed portion of the tubing to produce an open end at the cut, e.g., to produce an aspiration tip with a narrowed opening. Each side of the cut will potentially provide a narrowed open end: depending on the length of the narrowest portion of the conduit desired, one cut may be made, or more than one cut. The cut may be perpendicular to the axis of the tubing, or at any suitable angle to the axis of the tubing. FIG. 2 shows an exemplary cut to produce, e.g., an aspiration tip.

Also provided herein are systems for producing a narrowing of ID of a length of tubing, wherein the narrowing is, optionally, flanked on one or both sides by a taper to or from the narrowing. The system comprises (i) a conduit into which the tubing can be inserted, where the conduit has an ID that is greater than the OD of the tubing, e.g., greater in an amount as described herein, and where the conduit comprises a material that is capable of conducting heat quickly and uniformly to the tubing and that does not expand sufficiently on heating to a desired temperature to deform the tubing: (ii) a compression system configured to reversibly apply pressure to at least one end of the tubing after its insertion into the conduit: (iii) a heating element configured to be in contact with the conduit at a location corresponding to the location of the inserted tubing where narrowing of the ID is desired; and (iv) a mandrel to be inserted into the tubing, where the mandrel has cross-sectional dimensions corresponding to the desired cross-sectional dimensions of the narrowest portion of the tubing after it is narrowed: in cases where the mandrel is cylindrical, the OD of the mandrel corresponds to the desired ID of the narrowed portion of the tubing. The conduit can be in any suitable orientation relative to vertical: in some cases it is within 1, 2, 5, 7, 10, 15, 20, 30, 40, 50, 60, 70, for example, within 10 degrees, of vertical. The system can include a system to anchor a second end of the tubing after its insertion into the conduit. The location at which the heating element contacts the conduit can have a length that is no more than 0.1, 0.2, 0.5, 0.7, 1, 1.2, 1.5, 1.7, 2, 2.2, 2.5, 3, 3.5, 4, 5, 6, 7, 8, 9, 10, 12, or 15 times the OD of the tubing to be narrowed. The system can further comprise a cooling system to cool the conduit after heating, such as a mechanism to move air across the exterior of the conduit, e.g., a fan. The system can also include a temperature sensor in contact with the heating element, the conduit, the tubing, or a combination thereof. The system can comprise a control system in communication with the heating element, where the control system is configured to modulate heating at the heating element at a predetermined endpoint, such as a predetermined maximum temperature. The control system can send an output to modulate the heating at the heating element, at least in part in response to information received from the temperature sensor. Materials used for the conduit, mandrel, heating element, and the like are as described elsewhere herein.

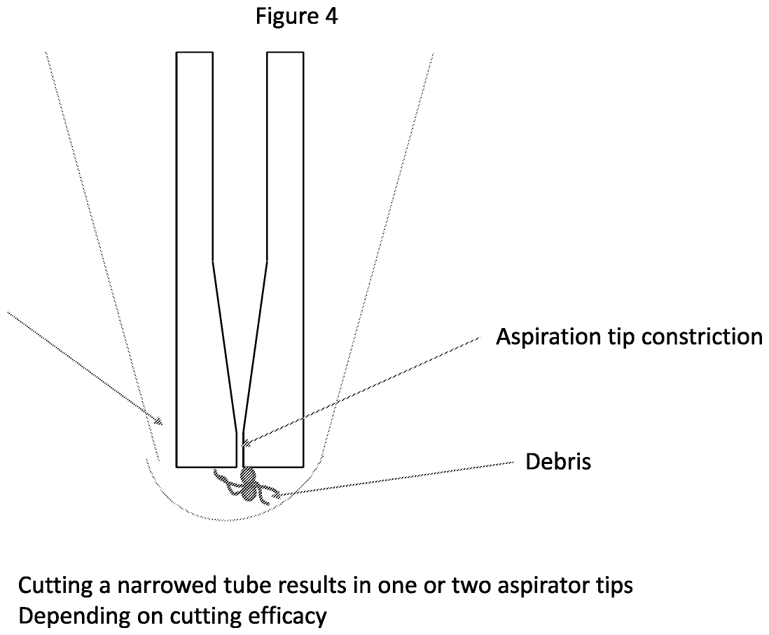

Also disclosed herein is a length of thermoplastic tubing. The tubing can be constructed of any material disclosed herein, such as PFA, and the tubing comprises a narrowed interior portion, where the ID of the tubing tapers to at least one end of the narrowed portion, or both ends, and wherein the narrowed portion of the interior has a length of at least 0.1, 0.2, 0.5, 0.6, 0.7, 0.8, 0.9, 1, 1.1, 1.2, 1.3, 1.4, 1.5, 1.6, 1.7, 1.8, 1.9, 2, 2.2, 2.5, 2.7, 3, 3.5, 4, 4.5, 5, 5.5, 6, 7, 8, 9, 10, 12, 15, or 20 mm and/or not more than 0.2, 0.5, 0.6, 0.7, 0.8, 0.9, 1, 1.1, 1.2, 1.3, 1.4, 1.5, 1.6, 1.7, 1.8, 1.9, 2, 2.2, 2.5, 2.7, 3, 3.5, 4, 4.5, 5, 5.5, 6, 7, 8, 9, 10, 12, 15, 20, or 30 mm, such as 0.5-5 mm, for example 0.5-3 mm, in some cases 1-2 mm: the narrowed portion can have any suitable dimensions: in the case of a narrowed portion with a circular cross-section, it can have any suitable ID, such as at least 0.05, 0.1, 0.15, 0.2, 0.25, 0.3, 0.35, 0.4, 0.45, 0.5, 0.6, 0.7, 0.8, or 0.9× the OD of the tubing and/or not more than 0.1, 0.15, 0.2, 0.25, 0.3, 0.35, 0.4, 0.45, 0.5, 0.6, 0.7, 0.8, 0.9 or 0.95× the OD of the tubing, or such as at least 1, 2, 5, 10, 30, 50, 70, 100, 120, 140, 160, 180, 200, 220, 240, 260, 280, 300, 320, 350, 400, 450, 500, 600, 700, 800, 900, 1000, 1200, 1500, 1700, 2000, 2500, 3000, 3500, 4000, 4500, or 5000 um and/or not more than 50, 70, 100, 120, 140, 160, 180, 200, 220, 240, 260, 280, 300, 320, 350, 400, 450, 500, 600, 700, 800, 900, 1000, 1200, 1500, 1700, 2000, 2500, 3000, 3500, 4000, 4500, 5000, or 10,000 um, for example 50-5000 um, or 100-3000 um, or 200-2000 um. The tapered portions can be any suitable length, such as at least 0.1, 0.2, 0.5, 0.7, 1.0, 1.3, 1.5, 1.7, 2, 2.5, 3, 3.5, 4, 5, 6, 7, 8, 9, or 10× the OD of the tubing and/or not more than 0.2, 0.5, 0.7, 1.0, 1.3, 1.5, 1.7, 2, 2.5, 3, 3.5, 4, 5, 6, 7, 8, 9, 10 or 15× the OD of the tubing, e.g., 1-3× the OD of the tubing, or such as 0.1, 0.2, 0.5, 0.7, 1, 1.2, 1.4, 1.6, 1.8, 2, 2.2, 2.4, 2.6, 2.8, 3, 3.2, 3.5, 3.7, 4, 4.5, 5, 6, 7, 8, 9, 10, 12, 15, or 20 mm and/or not more than 0.2, 0.5, 0.7, 1, 1.2, 1.4, 1.6, 1.8, 2, 2.2, 2.4, 2.6, 2.8, 3, 3.2, 3.5, 3.7, 4, 4.5, 5, 6, 7, 8, 9, 10, 12, 15, 20, or 30 mm, for example, 0.1-10 mm, or 0.2-8 mm, or 0.4-5 mm, or 0.5-4 mm. In certain embodiments, the tube has an OD of 1/16 inch and in the tapered and narrowed section, a taper of 0.5-4 mm and a narrowed section of constant diameter that extends 1-3 mm. In certain embodiments, the tubing has only one taper: in certain embodiments, the tubing has two tapers. In certain embodiments, such as an aspiration tube, the tubing has one taper and the narrow portion comprises an opening. The opening can be any suitable geometry, reflecting the geometry of the mandrel used to control the narrowed portion: in certain embodiments, the geometry is circular or substantially circular, with a diameter of 20-200, or 30-100 um, such as 50 um or 75 um. In certain embodiments, the geometry is rectangular, e.g., an elongated slot, for example, a slot with a long dimension of 50-500, or 100-400, or 150-300 um, such as 250 or 210 um, and a short dimension of 10-100, or 15-50, or 20-40 um, such as 25 or 35 um. The length of the taper to the narrowed portion at the opening can be any suitable length, such as 0.5-4 mm. The dimensions and geometry of the opening are determined by the use of the aspirator, for example, to prevent particles above a certain size from entering a system to which the aspirator tip is attached. See, e.g., FIG. 4. Further description can be found in, e.g., PCT Patent Application No. PCT/US2020/046033.

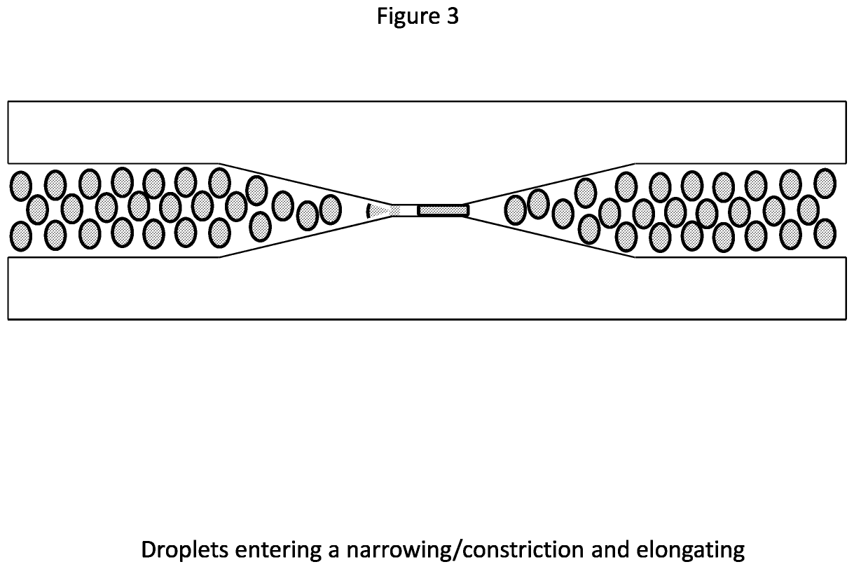

In certain embodiments the tubing is part of a detection system and the narrowed portion of the tubing comprises an interrogation region in the detection system. Typically, the tubing will have a circular cross-section. In particular, it is useful to have a narrowed section of conduit that has a smaller cross-sectional area than the average cross-sectional area of droplets passing through it, so that the droplets become elongated as they pass through. See, e.g., FIG. 3. Suitable detection systems are described in, e.g., US Patent Application Publication No. 20210023557.

### EXAMPLES

### Example 1

1/16″ ID PFA tubing was inserted into a stainless steel conduit, while threading a mandrel wire into the ID. The wire was pinched above the fixture while pushing the tubing up to approximately 2-5 mm from the top of the conduit. The bottom of the tubing was claimed just below the stainless steel conduit so that it was restricted from moving. A tamping needle was lowered into the top of the stainless steel conduit and a spring was compressed to its full range of travel. The needle fixture was secured in place, holding the PFA tubing in compression.

At T+0:00, the clock was started and a soldering iron was set to the lowest temperature setting (˜160 C) and turned on. It was allowed to heat for 90 seconds, allowing it to reach equilibrium. This step is needed to normalize the starting temperature, because if the fixture is used in succession the starting temperature may not be the same, producing inconsistent final results

At T+1:30 The soldering iron was set to 375 C (˜350 C as read by the thermocouple) and waited for 210 seconds, allowing time for the viscous material to flow.

At T+5:00 The soldering iron was set to to 300 C (˜260 C as read by the thermocouple), and the material was allowed to cool for 120 seconds, ensuring a gradual cooling rate.

At T+7:00 the soldering iron was turned off, and waited for 120 seconds for the part to cool

At T+9:00 the compression on the tamping needle was released and the fixture was lifted free.

The tubing clamp was removed at the bottom, and the mandrel wire was gently tugged to feel for some resistance, ensuring that the interior channel formed around the wire. While gently pinching the mandrel wire, gentle tension was used to extract the formed PFA tubing, using a simultaneous twisting and axial reciprocating motion. A fine abrasive pad was used for 30 seconds to improve the surface finish around the processed area.

### Example 2

Sleeving and bonding. It is possible to mechanically bond two different fluoropolymer materials together using the above techniques. To preserve dimensional stability, it is ideal to heat only to around the glass transition temperature (280 C) and not reach the melt point, though reaching the melt point will provide a superior and more robust mechanical connection. One common application is to nest two different tubing sizes concentrically as follows:
1. Insert section of 1/16″ OD×0.03″ ID tubing into 1/16″ ID glass tubing to constrain tubing geometry
2. Turn heat gun on to 260 C
3. Apply heat gun to end of 0.032″ OD blunt needle and gentle press the hot needle into the open end of the 0.03″ tubing until at least 2 cm of the needle has been inserted.
4. Remove heat and allow 15 seconds to cool
5. Removing needle and glass tubing fixture with firm but gentle pressure, avoiding deforming the 1/16″ tubing. Using a twisting action is often helpful.
6. Insert 1/32″ OD tubing into the newly widened bore of the 1/16″ tubing and insert entire assembly into 1/16″ ID glass tubing
7. Apply heat at 280 C for at least 20 seconds until the PFA tubing turns transparent
8. Remove heat, allow to cool for 20 seconds, and remove glass tubing fixture
9. Trim tubing end to get a clean and perpendicular face.

Polish the newly cut end be holding it perpendicular to a cloth polishing sheet and gently tracing a figure-8 path.

### Example 3

Resistive wire forming. This technique provides finer control and more reproducible results to apply spot heating for forming operations. This technique works well for forming both aspirator tips and squeeze separator tubing on both 1/32″ and 1/16″ OD PFA tubing.
1. Wrap 38 gauge nichrome resistance wire around the glass capillary tube (2 wraps) and connect either end to a constant current source
2. Apply compression to the tubing. One method is to use an additional nichrome wire wrap on either side of the melting area and bringing it up to near the glass transition temperature, at which point the tubing will expand enough to grab onto the capillary and continue expanding axially towards the melting area. A second method is to apply mechanical compression. Mechanical compression results in superior material reflow for a better surface finish but is more difficult to control.
3. Bring melting area to near the glass transition temperature by applying approximately 0.4 A and allowing at least 30 seconds. Rushing this step increases the risk of forming the tubing asymmetrically.
4. Gradually increase the current to 0.5 A over the course of approximately 30 seconds.
5. Gradually decrease the current back to the glass transition temperature of around 0.4 A. Allowing the tubing to solidify gradually improves the symmetry and surface finish of the part.
6. Gradually decrease the current down to 0, allowing the part to cool to room temperature.

The number and spacing between wire wraps changes how much current is required to melt the tubing. More and tighter wraps require less current, and tighter wraps cause a stronger temperature gradient. When applying this technique to 1/16″ Tubing and the correspondingly larger glass capillaries, higher currents and longer times are required. When just past the melting point, it can take up to 2 minutes for the plastic to reflow and reach steady-state. If too much length of tubing is melted, it can become impossible to extract the tubing from the glass capillary, therefore it is important to try to melt a minimal length of tubing when executing forming operations. Reducing the heating element to about 50% power from the melting current makes extracting the tubing from the glass capillary significantly easier, compared to allowing it to cool to room temperature first

### Example 4

Using a glass mold produces exceptionally clear and consistent product. In addition to the potential steel corrosion effect, it seems likely that the friction effect from the steel tubing mandrel (which is a tighter fit than the glass tube) may limit transmission of the compression all the way to the melt zone. An ideally-formed product can be created in the glass tube with temperatures as low as 250 C with no additional holding time, and it is likely that is not the lower bound. This is a surprising effect considering this is well below the melting temperature, and even within the specified operating range of PFA. An advantage of this operating range is that the tubing exhibits no tendency to stick to the mold. Further investigation of the effect on mold friction may be warranted, though using an all-glass mold seems to be a viable strategy. A more robust fixture is in production.

Using a rapid cooldown (forced air convection) produces a good result with excellent dimensional stability and optical clarity. There appears to be no reason to use a prolonged warm up or cool down

There appears to be a strong relationship between compression force and the taper geometry. Given the repeatability and precision of the heating fixturing, it is likely warranted to use a more controlled approach to applying compression. Informal experimental test shows that a peak of around 7 lb (2300 psi) has been applied and is likely excessive, forming a very long taper.

Arduino control system relies on supply 24V. This file is optimized for ˜260 C melt temp and relies heavily on a feed forward term. It is likely unnecessary to use a PID control system and can be simplified to a pure thermostat system, cutting heater power and turning on forced cooling at a specific setpoint. The cavities for the heater cartridge and the thermocouple head should be slightly enlarged during the next fabrication

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method for narrowing the inside diameter (ID) of a tubing comprising a heat-deformable material, the method comprising:
(i) positioning the tubing inside a conduit, wherein the conduit has an ID greater than the outside diameter (OD) of the tubing;
(ii) positioning a mandrel inside the tubing, wherein:
(a) the mandrel is present at least at an area of the tubing desired to be narrowed to a desired ID, and
(b) the mandrel has an OD that is substantially equal to the desired ID of the tubing; and
(iii) applying heat to the area of the tubing desired to be narrowed to heat the tubing to a sufficient temperature and for a sufficient time such that the ID of the tubing is narrowed to the desired ID in the area.

2. The method of claim 1, wherein the conduit has an ID no more than 5% greater than the OD of the tubing.

3. The method of claim 1, wherein the ID of the conduit is no more than 2 thousandths of an inch greater than the OD of the tubing.

4. The method of claim 1, further comprising applying a compressive force to the tubing in the direction of the long axis of the tubing.

5-7. (canceled)

8. The method of claim 1, wherein the long axis of the mandrel is within 50 μm of the long axis of the tubing in the area in which the tubing is to be narrowed.

9. The method of claim 1, further comprising, after step (iii), treating an outer surface of the tubing to improve its optical characteristics.

10. The method of claim 1, wherein the heat-deformable material comprises a thermoplastic material.

11. The method of claim 10, wherein the thermoplastic material comprises a fluoropolymer.

12. (canceled)

13. The method of claim 1, wherein the tubing comprises a material with a glass transition temperature and a melting temperature, wherein the melting temperature is higher than the glass transition temperature.

14. The method of claim 13, wherein the tubing is heated to a maximum temperature that is below the melting temperature.

15. The method of claim 13, wherein the tubing is heated to a temperature that is within 5% of the glass transition temperature.

16. The method of claim 1, wherein the tubing is heated to between 260 and 300° C.

17. The method of claim 13, wherein the tubing is heated to a maximum temperature that is below the glass transition temperature.

18. The method of claim 14, wherein the tubing is heated by a heating element in contact with the conduit, and the temperature is measured at the heating element or conduit, and the temperature of the tubing is assumed to reach a maximum within 10° C. of the temperature of the heating element or conduit.

19-23. (canceled)

24. The method of claim 1, further comprising, after the tubing has been narrowed, cutting the tubing in the narrowed portion.

25. The method of claim 1, wherein the conduit comprises metal or glass.

26. (canceled)

27. The method of claim 1, wherein the tubing is heated by applying heat to the conduit and allowing heat to be conducted by the conduit to the tubing.

28-31. (canceled)

32. The method of claim 1, wherein the area of the tubing to which heat is applied has a length no greater than 2× the OD of the tubing.

33-36. (canceled)

37. An apparatus for narrowing the ID of a tubing comprising heat-deformable material to a desired ID, comprising:
(i) a conduit into which the tubing can be inserted, wherein the conduit:
(a) has an ID that is greater than the OD of the tubing, and
(b) comprises a material that is capable of conducting heat to the tubing;
(ii) a heating element in contact with the conduit at a location corresponding to a location of tubing, when inserted into the conduit, where narrowing of the ID of the tubing is desired; and
(iii) a mandrel to be inserted into the tubing, wherein the mandrel has an OD corresponding to the desired ID of the tubing.

38-46. (canceled)

47. A composition comprising a length of tubing wherein a portion of the tubing comprises a section with a narrowed ID compared to other sections of the tubing, wherein the ID of the tubing tapers to the narrowed ID over a length of at least 4 times the length of tubing, and wherein the tubing has uniform optical transmittance around the circumference of the tubing.
